(19) United States
(12) Patent Application Publication
(10) Pub. No.: US 2021/0373335 A1
(43) Pub. Date: Dec. 2, 2021

(54) HEAD MOUNTED DISPLAY

(71) Applicant: HTC Corporation, Taoyuan City (TW)

(72) Inventors: Meng-Che Tsai, Taoyuan City (TW); Kuei-Chun Liu, Taoyuan City (TW); Ching-Chia Chou, Taoyuan City (TW); Sheng-Le Wang, Taoyuan City (TW)

(73) Assignee: HTC Corporation, Taoyuan City (TW)

(21) Appl. No.: 16/886,784

(22) Filed: May 29, 2020

(51) Int. Cl. G02B 27/01

(52) U.S. Cl. CPC G02B 27/0172; G02B 2027/0123

(57) ABSTRACT

A head mounted display is provided, including a transmissive display, a first lens, a second lens, and a beam splitter coating. The transmissive display includes an active surface. The transmissive display generates a display image beam on the active surface. The first lens includes a first surface facing the active surface of the transmissive display, and a second surface opposite to the first surface. The second lens includes a third surface and a fourth surface opposite to each other. The beam splitter coating is disposed between the second surface of the first lens and the third surface of the second lens. The third surface of a second lens and the second surface of the first lens are attached to each other through the beam splitter coating, the first lens is a convex lens, and the second lens is a concave lens.

### BACKGROUND

### Technical Field

The disclosure relates to a head mounted display, and in particular, to a head mounted display which may expand a field of view.

### Description of Related Art

A large field of view (FOV) and volume miniaturization are important indicators for an augmented-reality head mounted display device. In currently available augmented reality technologies, in order to also obtain an optical-see-through function, an optical element is specifically disposed to generate a magnified virtual image for the human eye, and a user is simultaneously allowed to see the surrounding environment. Due to the volume and weight resulting from the optical element disposed in the conventional technologies, it is usually difficult to expand the field of view, and the field of view may only be 53 degrees or below in most cases, which poses various limitations to the content presented with augmented reality and the application design. The limitation on the field of view also seriously affects the sense of immersion of the user, making it difficult to also apply the content on a virtual reality platform to an augmented reality device.

### SUMMARY

The invention provides a head mounted display, which may effectively expand a range of the field of view while maintaining a light weight.

The head mounted display of the invention includes a transmissive display, a first lens, a second lens, and a beam splitter coating. The transmissive display includes an active surface. The transmissive display generates a display image beam on the active surface. The first lens includes a first surface facing the active surface of the transmissive display, and a second surface opposite to the first surface. The second lens includes a third surface and a fourth surface opposite to each other. The beam splitter coating is disposed between the second surface of the first lens and the third surface of the second lens. The third surface of a second wafer and the second surface of the first lens are attached to each other through the beam splitter coating, the first lens is a convex lens, and the second lens is a concave lens.

Based on the foregoing, in the embodiments of the invention, the first lens, the beam splitter coating, and the second lens attached to each other are disposed. In addition, the display image beam generated by the transmissive display is reflected, and the external ambient light beam is transmitted simultaneously. In this way, the field of view of the head mounted display is effectively expanded without an increase of a size of the head mounted display. Therefore, the display quality may be effectively improved with a light and thin design.

### BRIEF DESCRIPTION OF THE DRAWINGS

FIG. 1 shows a schematic diagram of a head mounted display according to an embodiment of the invention.

FIG. 2 shows a schematic diagram of optical paths generated by a first lens, a second lens, and a beam splitter coating in a head mounted display device according to an embodiment of the invention.

FIG. 3A to FIG. 3C show schematic diagrams of transmission of an image beam according to an embodiment of the invention.

### DESCRIPTION OF THE EMBODIMENTS

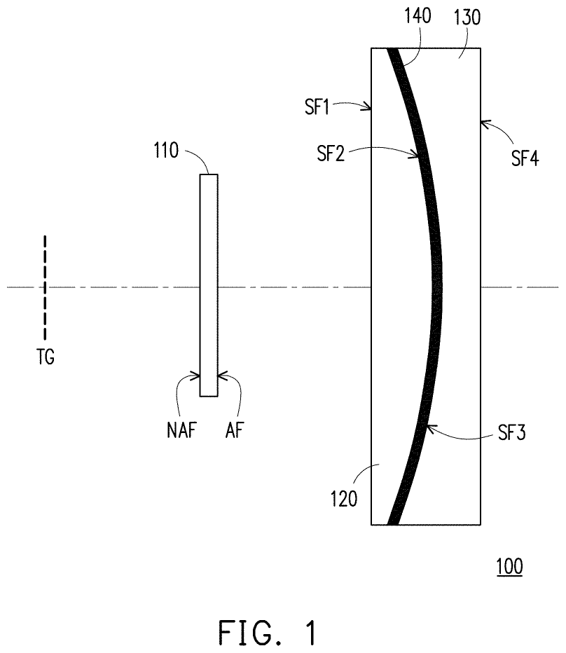

Referring to FIG. 1, FIG. 1 shows a schematic diagram of a head mounted display according to an embodiment of the invention. A head-mounted display 100 includes a transmissive display 110, a first lens 120, a second lens 130, and a beam splitter coating 140. The transmissive display 110 includes an active surface AF. The transmissive display 110 is configured to generate a display image beam on the active surface AF. The first lens 120 includes a first surface SF1 and a second surface SF2. The first surface SF1 of the first lens 120 faces the active surface of the transmissive display 110. The second surface SF2 of the first lens 120 is opposite to the first surface SF1 of the first lens 120. The second lens 130 includes a third surface SF3 and a fourth surface SF4 opposite to each other. The beam splitter coating 140 is disposed between the second surface SF2 of the first lens 120 and the third surface SF3 of the second lens 130. In the present embodiment, the third surface SF3 of the second lens 130 penetrates through the beam splitter coating 140 to be attached to the second surface SF2 of the first lens 120.

In the present embodiment, the first lens 120 is a convex lens, and the second lens 130 is a concave lens. A display image beam generated on the active surface AF of the transmissive display 110 may be projected onto the first surface SF1 of the first lens 120. The display image beam may be further transmitted to the beam splitter coating 140 on the second surface SF of the first lens 120. The beam splitter coating 140 may reflect the received display image beam to generate a reflected display image beam, and transmit the reflected display image beam through the transmissive display 110 to be projected to a target region TG. The target region TG is an exit pupil position of the head mounted display 100 and corresponds to a position of an eyeball of a user of the head mounted display 100. The eyeball of the user of the head mounted display 100 faces a non-active surface NAF of the transmissive display 110.

In addition, in the present embodiment, an ambient light beam may be received by the fourth surface SF4 of the second lens 130. The ambient light beam may be transmitted to the third surface SF3 of the second lens 130 and penetrate through the beam splitter coating 140, and generate a focused ambient light beam according to a focusing effect generated by the second lens 130 and the first lens 120. The focused ambient light beam may be transmitted to penetrate through the transmissive display 110 and transmitted to the target region TG.

It should be noted herein that in the present embodiment, the first surface SF1 of the first lens 120 may include a first curvature CR1, and the second surface SF2 of the first lens 120 may include a second curvature CR2. An absolute value of the first curvature CR1 is less than an absolute value of the second curvature CR2. The third surface SF3 of the second lens 130 may include a third curvature CR3, and the fourth surface SF4 of the second lens 130 may include a fourth curvature CR4. An absolute value of the third curvature CR3 is greater than an absolute value of the fourth curvature CR4. In addition, the first curvature CR1 may be the same as the fourth curvature CR4, and a sum of the second curvature CR2 and the third curvature CR3 may be 0.

In particular, the second surface SF2 of the first lens 120 may be a convex surface, and the third surface SF3 of the second lens 130 may be a concave surface. In addition, the first surface SF1 of the first lens 120 and the fourth surface SF4 of the second lens 130 may be flat surfaces with a same curvature or curved surfaces with the same curvature.

Incidentally, in the present embodiment, the transmissive display 110, the first lens 120, the beam splitter coating 140, and the second lens 130 may be disposed in a tube of the head mounted display 100.

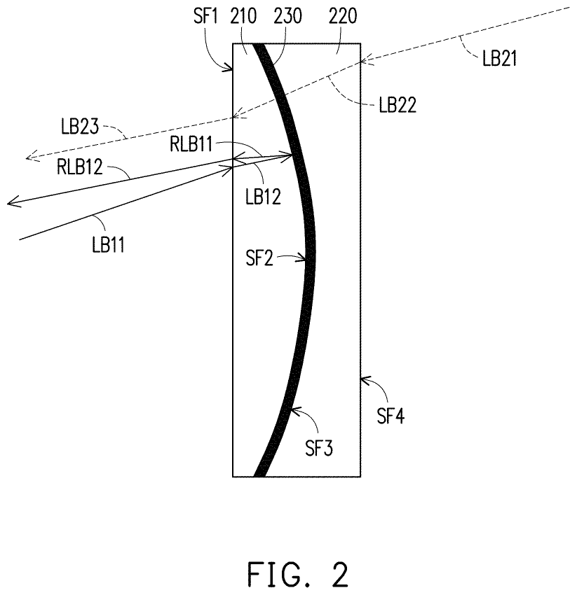

Referring to FIG. 2 below, FIG. 2 shows a schematic diagram of optical paths generated by a first lens, a second lens, and a beam splitter coating in a head mounted display device according to an embodiment of the invention. In FIG. 2, a first lens 210 includes a first surface SF1 and a second surface SF2 opposite to each other. A second lens 220 includes a third surface SF3 and a fourth surface SF4 opposite to each other. A beam splitter coating 230 exists between the second surface SF2 of the first lens 210 and the third surface SF3 of the second lens 220 that are glued to each other. In addition, the second surface SF2 of the first lens 210 is a convex surface, and the third surface SF3 of the second lens 220 may be a concave surface.

In FIG. 2, a light beam LB11 is projected onto the first surface SF1 of the first lens 210. The first lens 210 deflects the light beam LB11 to generate a light beam LB12. The LB12 travels in the first lens 210 and is transmitted to the beam splitter coating 230 on the second surface SF2 of the first lens 210. The beam splitter coating 230 causes the light beam LB12 to reflect and generates a reflected light beam RLB11. The reflected light beam RLB11 travels from the second surface SF2 of the first lens 210 toward a direction of the first surface SF1 of the first lens 210, and deflects on the first surface SF1 of the first lens 210 to generate the reflected light beam RLB12. The reflected light beam RLB12 may be projected to the target region.

In addition, the other light beam LB21 may be transmitted to the fourth surface SF4 of the second lens 220 from an outside of the fourth surface SF4 of the second lens 220. The second lens 220 may deflect the light beam LB21 to generate a light beam LB22, and cause the light beam LB22 to travel in the second lens 220 and be transmitted to the beam splitter coating 230 on the third surface SF3 of the second lens 220. The beam splitter coating 230 may cause the light beam LB22 to be penetrated and transmitted to the first lens 210. When the light beam LB22 is transmitted onto the first surface SF1 of the first lens 210, the optical path is deflected again, and a light beam LB23 is generated to be transmitted out of the first lens 210. The light beam LB23 may be transmitted to the target region.

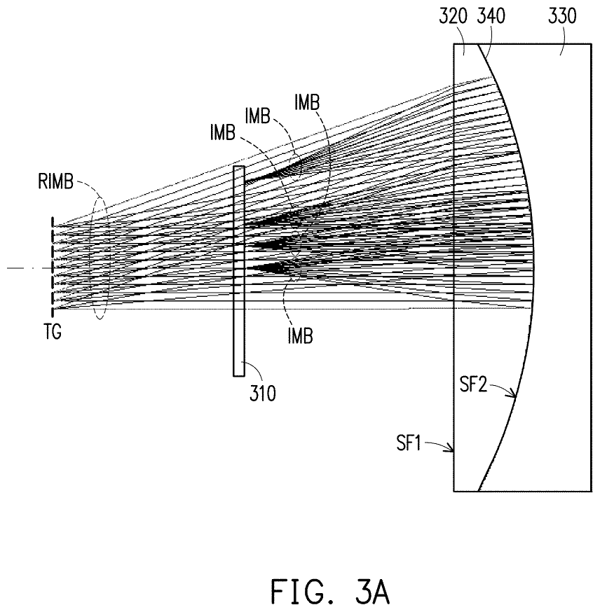

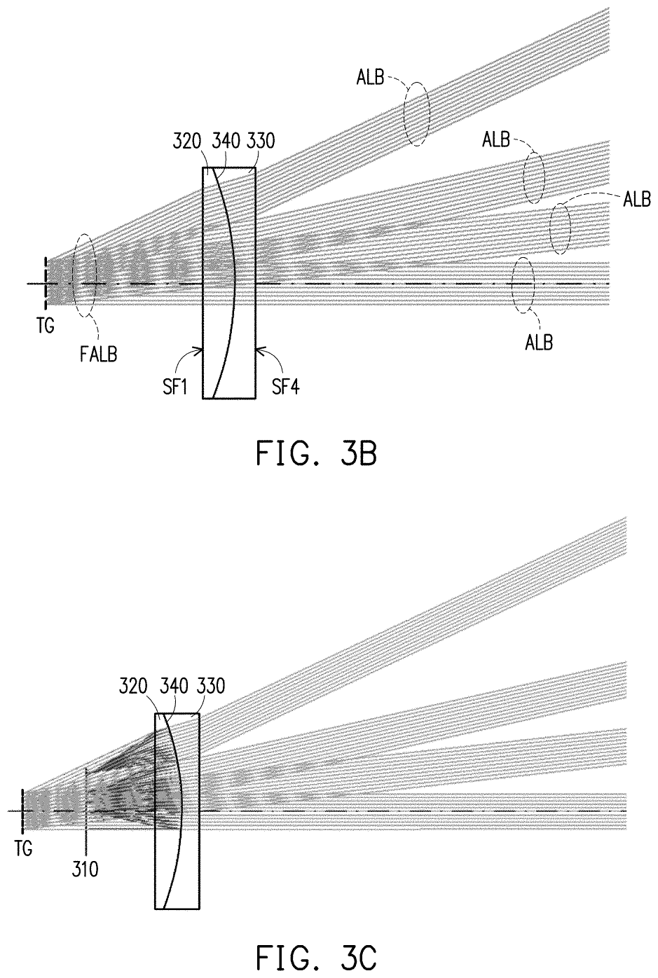

Referring to FIG. 3A to FIG. 3C below, FIG. 3A to FIG. 3C show schematic diagrams of transmission of an image beam according to an embodiment of the invention. In FIG. 3A, a transmissive display 310 penetrates through an active surface to generate a display image beam IMB. The display image beam IMB is projected onto a first lens 320, and is transmitted through a first surface SF1 of the first lens 320 to a beam splitter coating 340 on a second surface SF2.

The beam splitter coating 340 is configured to reflect the display image beam IMB to generate a reflected display image beam RIMB. The reflected display image beam RIMB penetrates through the first surface SF1 of the first lens 320 to be transmitted to a target region TG behind the transmissive display 310.

In the present embodiment, the display image beam IMB may be an image beam of a virtual reality image. Through the reflected display image beam RIMB transmitted to the target region TG, a user may smoothly observe a virtual reality image generated on an active surface of the transmissive display 310.

In FIG. 3B, an ambient light beam ALB may be transmitted to a fourth surface SF4 of a second lens 330 from an outside of the fourth surface SF4 of the second lens 330. The ambient light beam ALB may sequentially penetrate through the fourth surface SF4 of the second lens 330, the beam splitter coating 340, and the first surface SF1 of the first lens 320, and a focused ambient light beam FALB is generated through a focusing effect generated by the second lens 330 and the first lens 320. The focused ambient light beam FALB may be projected to the target region TG. In this way, the ambient light beam ALB within a large range may be focused and projected to the target region TG, so that the user may observe an ambient image within a large field of view.

FIG. 3C is a combination of FIG. 3A and FIG. 3B. The first lens 320, the beam splitter coating 340, and the second lens 330 are disposed to cause the display image and the ambient image generated by the transmissive display 310 to be projected respectively, through the reflected display image beam and the focused ambient light beam, to the target region TG at the same time or at different time. In this way, the user may observe a display effect of virtual reality, augmented reality, or mixed reality.

Based on the foregoing, according to the invention, a lens group is disposed in the tube of the head mounted display device, and the beam splitter coating in the lens group is used to reflect one part of the light beam and the other part of the light beam is transmitted, thereby expanding the field of view. In this way, the head mounted display device of the invention may expand the field of view with a light and thin design, effectively improving product competitiveness of the head mounted display device.

1. A head mounted display, comprising:
a transmissive display, having an active surface and generating a display image beam on the active surface;
a first lens, having a first surface facing the active surface of the transmissive display and a second surface opposite to the first surface;
a second lens, having a third surface and a fourth surface opposite to each other; and
a beam splitter coating, disposed between the second surface of the first lens and the third surface of the second lens, wherein
the third surface of the second lens and the second surface of the first lens are attached to each other through the beam splitter coating, the first lens is a convex lens, and the second lens is a concave lens.

2. The head mounted display according to claim 1, wherein the transmissive display further has a non-active surface opposite to the active surface, wherein the non-active surface faces a user.

3. The head mounted display according to claim 1, wherein the first surface of the first lens has a first curvature, the second surface of the first lens has a second curvature, and an absolute value of the first curvature is less than an absolute value of the second curvature.

4. The head mounted display according to claim 3, wherein the third surface of the second lens has a third curvature, the fourth surface of the second lens has a fourth curvature, and an absolute value of the third curvature is greater than an absolute value of the fourth curvature.

5. The head mounted display according to claim 4, wherein the first curvature is the same as the fourth curvature.

6. The head mounted display according to claim 4, wherein a sum of the second curvature and the third curvature is 0.

7. The head mounted display according to claim 1, wherein the beam splitter coating reflects the display image beam and transmits a reflected display image beam to a target region.

8. The head mounted display according to claim 7, wherein the fourth surface of the second lens receives an ambient light beam, the beam splitter coating transmits the ambient light beam, and the second lens and the first lens focus the ambient light beam and cause a focused ambient light beam to be transmitted to the target region.

9. The head mounted display according to claim 1, wherein the second surface of the first lens, the beam splitter coating, and the third surface of the second lens are glued to each other.

10. The head mounted display according to claim 7, wherein the target region is an exit pupil position of the head mounted display.
